(19) United States
(12) Patent Application Publication
(10) Pub. No.: US 2026/0097723 A1
(43) Pub. Date: Apr. 9, 2026

(54) RETENTION ASSEMBLY FOR COUPLING WIRING HARNESS TO VEHICLE HAVING ELECTRICAL GROUND

(71) Applicant: Ford Global Technologies, LLC, Dearborn, MI (US)

(72) Inventors: Zachary James Kadykowski, Chelsea, MI (US); Kurt Michael Lundeen, Novi, MI (US); Derrick Miller, Ypsilanti, MI (US)

(73) Assignee: Ford Global Technologies, LLC, Dearborn, MI (US)

(21) Appl. No.: 18/909,205

(22) Filed: Oct. 8, 2024

(51) Int. Cl. B60R 16/02; H01R 4/34

(52) U.S. Cl. CPC B60R 16/0215; H01R 4/34

(57) ABSTRACT

A retention assembly for coupling electrical components to a vehicle including a body configured to house the electrical components, the body defining a slot. The retention assembly further includes a grounding component received in the slot of the body and defining a first aperture and a fastener extending through the first aperture of the grounding component and configured to extend at least partially through a vehicle body to secure the body to the vehicle and provide an electrical pathway between the grounding component and the vehicle body.

### FIELD

The present disclosure relates to a retention assembly for coupling a wire harness to a vehicle having an electrical ground.

### BACKGROUND

The statements in this section merely provide background information related to the present disclosure and may not constitute prior art.

Industrial robots have been used for a variety of manufacturing operations, including by way of example, welding and moving parts from one location to another such as retrieving parts from a storage location and moving them to an assembly station. Automating the moving of some vehicle parts such as wire harnesses, for example, may be challenging because of the lack of proper handling of the part and mechanical repeatability.

These issues related to automating the handling of components, among other issues related to processing the components, are addressed by the present disclosure.

### SUMMARY

This section provides a general summary of the disclosure and is not a comprehensive disclosure of its full scope or all of its features.

In one form, the present disclosure discloses a retention assembly for coupling electrical components to a vehicle. The retention assembly includes a body, a grounding component, and a fastener. The body is configured to house the electrical components and defines a slot. The grounding component is received in the slot of the body and defines a first aperture. The fastener extends through the first aperture of the grounding component and is configured to extend at least partially through a vehicle body to secure the body to the vehicle and provide an electrical pathway between the grounding component and the vehicle body.

In variations of the retention assembly of the above paragraph, which may be implemented individually or in any combination: the grounding component cooperates with the body to inhibit rotation the grounding component about an axis of the first aperture; the body is a wiring harness body; the body defines a second aperture, and wherein the fastener extends through the second aperture of the body; the body includes a tab defining a cavity, the slot, and a second aperture; the slot and the second aperture are in communication with the cavity, the slot opens through a first side of the tab, and the second aperture opens through a second side of the tab, wherein the grounding component is received in the cavity of the tab through the slot, and wherein the fastener extends through the second aperture of the body; a compression limiter disposed at least partially within the cavity of the tab; the compression limiter includes a first axial end and a second axial end, an axial surface of the first axial end is flush with a third side of the tab and the second axial end engages the grounding component, and wherein the third side is opposite the second side; the body includes a collar that defines the slot; the grounding component includes a protrusion extending from a periphery of the grounding component, and wherein the slot is configured to receive the protrusion of the grounding component to inhibit rotation of the grounding component relative to the body; at least one collar disposed about the body, the at least one collar including a protrusion extending from a periphery of the at least one collar, and wherein the protrusion of the at least one collar is configured to cooperate with a corresponding aperture in the vehicle body to further secure the body to the vehicle body.

In another form, the present disclosure discloses a retention assembly for coupling electrical components to a vehicle. The retention assembly includes a wiring harness body, a grounding component, and a fastener. The wiring harness body is configured to house the electrical components and defines a slot. The grounding component is received in the slot of the wiring harness body and defines a first aperture. The grounding component also cooperates with the wiring harness body to inhibit rotation of the grounding component about an axis of the first aperture. The fastener extends through the first aperture of the grounding component, a second aperture of the wiring harness body, and is configured to extend at least partially through a vehicle body to secure the wiring harness body to the vehicle body and provide an electrical pathway between the grounding component and the vehicle body.

In variations of the retention assembly of the above paragraph, which may be implemented individually or in any combination: the wiring harness body includes a tab defining a cavity, the slot, and a second aperture; the slot and the second aperture are in communication with the cavity, the slot opens through a first side of the tab, and the second aperture opens through a second side of the tab, wherein the grounding component is received in the cavity of the tab through the slot, and wherein the fastener extends through the second aperture of the wiring harness body; a compression limiter disposed within the cavity of the tab; the compression limiter includes a first axial end and a second axial end, an axial surface of the first axial end is flush with a third side of the tab and the second axial end engages the grounding component, and wherein the third side is opposite the second side; and the wiring harness body includes a collar that defines the slot; at least one collar disposed about the wiring harness body, each collar of the at least one collar including a protrusion extending from a periphery of each collar, wherein each protrusion of each collar is configured to cooperate with a corresponding aperture in the vehicle body to further secure the wiring harness body to the vehicle body.

In yet another form, the present disclosure a retention assembly for coupling electrical components to a vehicle. The retention assembly includes a wiring harness body, a grounding component, and a fastener. The wiring harness body is configured to house the electrical components and includes a tab defining a cavity, a first aperture, and a second aperture. The first aperture and the second aperture are in communication with the cavity. The first aperture opens through a first side of the tab and the second aperture opens through a second side of the tab. The grounding component is received in the cavity of the tab through the first aperture., The grounding component cooperates with the tab of the wiring harness body to inhibit a rotation of the grounding component about an axis of the first aperture. The grounding component defines a third aperture. The fastener extends through the second aperture of the tab, the third aperture of the grounding component, and configured to extend at least partially through a vehicle body to secure the wiring harness body to a vehicle body and provide an electrical pathway between the grounding component and the vehicle body.

In variations of the retention assembly of the above paragraph, which may be implemented individually or in any combination: a compression limiter disposed within the cavity of the tab, wherein the compression limiter includes a first axial end and a second axial end, an axial surface of the first axial end is flush with a third side of the tab and the second axial end engages the grounding component, and wherein the third side is opposite the second side; the wiring harness body includes a collar that defines the tab; and at least one collar disposed about the wiring harness body, the at least one collar including a protrusion extending from a periphery of the at least one collar, wherein the protrusion of the at least one collar is configured to cooperate with a corresponding aperture in the vehicle body to further secure the wiring harness body to the vehicle body.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of a system for handling vehicle components of a vehicle according to the principles of the present disclosure, the vehicle components being secured to a part support of the system;

FIG. 2A is a perspective view of a portion of one of the vehicle components of FIG. 1 according to the principles of the present disclosure;

FIG. 2B is a perspective view of the vehicle component of FIG. 2A and a grounding component being assembled to a vehicle;

FIG. 2C is a perspective view of the vehicle component of FIG. 2A and the grounding component assembled to the vehicle;

FIG. 2D is another perspective view of the portion of the vehicle component of FIG. 2A;

FIG. 3 is a flowchart illustrating a method for assembling a vehicle component to a vehicle in accordance with the principles of the present disclosure;

FIG. 4A is a perspective view of another vehicle component and a grounding component assembled to a vehicle according to the principles of the present disclosure;

FIG. 4B is another perspective view of the vehicle component of FIG. 4A; and

FIG. 5 is a perspective view of the vehicle component of FIG. 4A including multiple collars for coupling the vehicle component to the vehicle according to principles of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

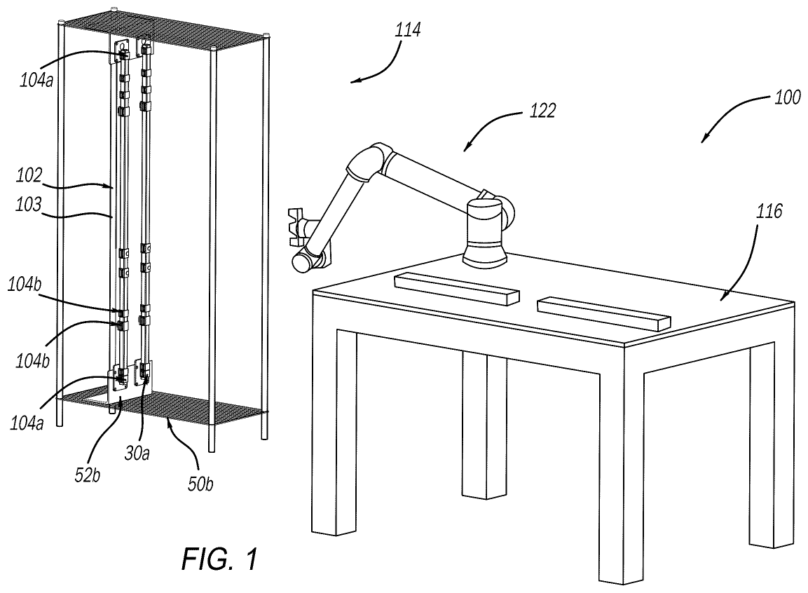

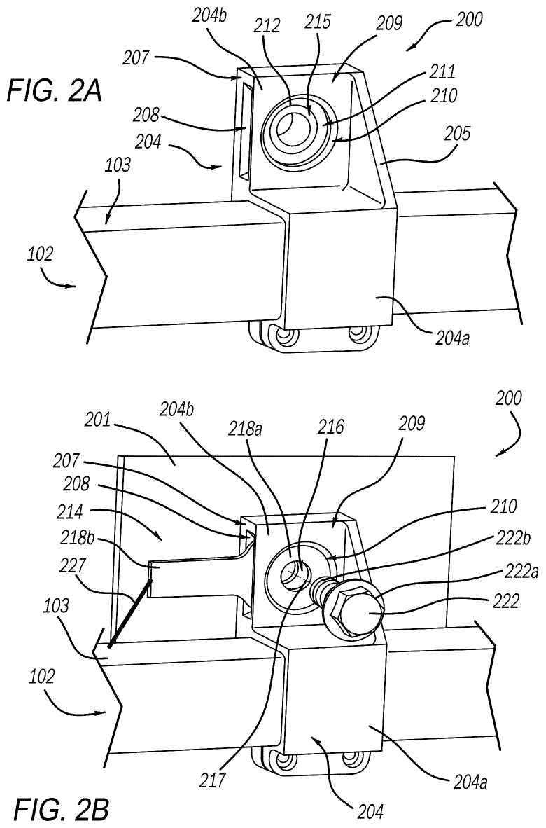

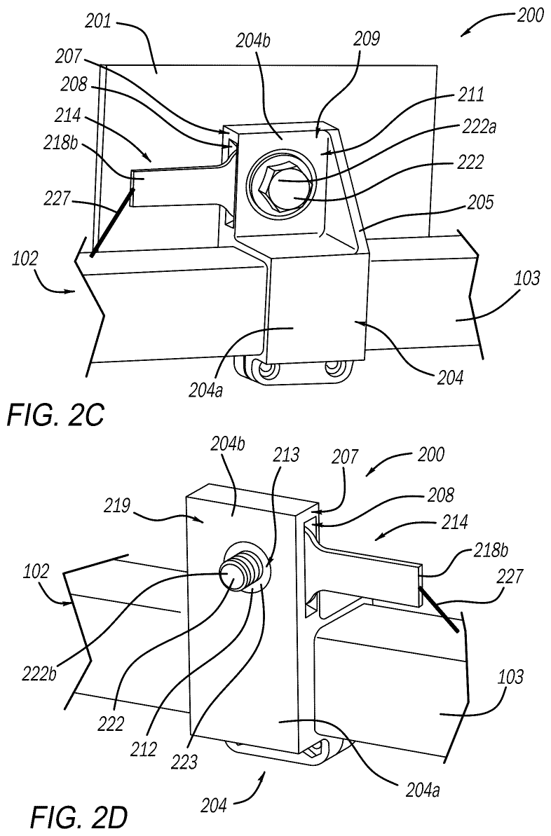

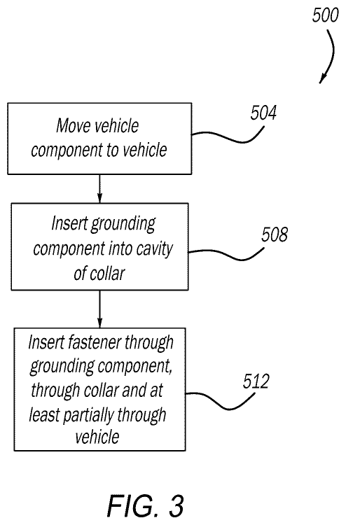

With reference to FIG. 1, a system 100 for handling one or more vehicle components 102 is illustrated. The handling of the vehicle components 102 may include retrieving the vehicle components 102 from a part support (e.g., a dunnage rack), placing the vehicle components 102 onto a work surface 116, manipulating parts of the vehicle components 102 on the work surface 116, and/or installing the vehicle components 102 into a machine 201 or a vehicle 201 (FIGS. 2B and 2C). The system 100 allows for the handling of the vehicle components 102 with little to no human intervention. In this way, the handling of the vehicle components 102 may be automated to increase productivity, reduce cycle time, and reduce variation and error, for example. In the example illustrated, the vehicle components 102 include electrical components such as wire harnesses. That is, wire harnesses tend to be flexible, complex, and highly variable from one part to the next, so that installation of the wire harness into the machine may be challenging to automate. The system 100 of the present disclosure provides for the adaptation of vehicle components 102 such as wire harnesses to better support automation. It should be understood that the vehicle components 102 may be other components of a vehicle other than wire harnesses.

With reference to FIG. 1, the system 100 may include the vehicle components 102, a part support 114, one or more robots 122, and a controller (not shown). Each vehicle component 102 may be moved to a fixture (not shown) on the work surface 116 from the part support 114. One example of a system for moving the vehicle component 102 from the part support 114 to the fixture is disclosed in U.S. patent application Ser. No. ______/000,000, and titled “SYSTEM FOR HANDLING A COMPONENT OF A VEHICLE” which is commonly owned with the present application and the contents of which are incorporated herein by reference in its entirety. With reference to FIG. 1, each vehicle component 102 includes a housing or body 103 and a plurality of collars 104a, 104b, 204. The body 103 may be made of a rigid material (e.g., metal or plastic) and may house electrical components (e.g., flexible wires). In the example illustrated, the body 103 is hollow and has a square shape. In some forms, the body 103 may have a circular shape, rectangular shape, or any other suitable shape that may be house electrical components.

In the example illustrated, the body 103 includes multiple sections that are movable relative to each other. For example, the sections may be coupled to each other (e.g., folding onto each other) as the vehicle component 102 moves from the part support 114 to the fixture (not shown). In this way, moving the vehicle component 102 to the fixture is facilitated. Once the vehicle component 102 is coupled to the fixture, the sections of the vehicle component 102 may be decoupled from each other (e.g., unfolded from each other) using the robot 122 and positioned at predetermined positions with respect to each other for further processing. It should be understood that the electrical components (e.g., wires) extend through the sections of the body 103 and may have ends that are secured to the body 103 via collars (not shown).

The collars 104a may be coupled at opposing ends of the section of the vehicle component 102 and may be configured to attach the vehicle component 102 to the part support 114. One example of such collar is disclosed in U.S. patent application Ser. No. ______/000,000, and titled “SYSTEM FOR HANDLING A COMPONENT OF A VEHICLE” which is commonly owned with the present application and the contents of which are incorporated herein by reference in its entirety. The collars 104b may be coupled to the vehicle component 102 between the collars 104a and may be configured to allow the robot 122 to grasp the vehicle component 102 for moving from the part support 114 to the fixture (not shown). One example of such collar is disclosed in U.S. patent application Ser. No. ______/000,000, and titled “SYSTEM FOR HANDLING A COMPONENT OF A VEHICLE” which is commonly owned with the present application and the contents of which are incorporated herein by reference in its entirety.

Referring to FIGS. 2A-2D, each collar 204 (only one shown in the figures) couples the vehicle component 102 to the vehicle 201 (FIGS. 2B and 2C) and facilitates electrical grounding of electrical components (not shown) of the vehicle component 102 to the vehicle 201. In the example illustrated, the collar 204 is a separate component coupled to the body 103 such that the collar 204 surrounds the body 103. The collar 204 also has end portions defining apertures. Mechanical fasteners (not shown) may extend through the apertures of the end portions, thereby securing (e.g., clamping) the collar 204 onto the body 103. In the example illustrated, the collar 204 is made of a single, monolithic body that is secured to the body 103. In some forms, the collar 204 may be made of two parts or shells that are secured to each other around the body 103. In another form, the body 103 may be manufactured (e.g., injection molded or 3D printed) to include the collar 204. In this way, the body 103 may be a unitary, monolithic component including the features of the collar 204.

In the example illustrated, the collar 204 includes a vehicle component portion 204a and a retention portion or tab 204b. The vehicle component portion 204a defines an aperture (not specifically shown) that has a shape that corresponds to the square shape of the body 103. In this way, the body 103 may be received in the aperture of the vehicle component portion 204a of the collar 204.

The retention portion 204b extends from a periphery of the vehicle component portion 204a and defines a slot 208, an aperture 210, and a cavity 211. The slot 208 is configured to receive a grounding component 214 and opens through a first side 207 of the tab 204b. In the example illustrated, the slot 208 is in communication with the cavity 211 and has a generally rectangular shape (FIG. 2A). In some forms, the slot 208 may have an oval shape or any other suitable shape that is allowed to receive the grounding component 214.

The grounding component 214 is configured to provide electrical grounding for the electrical components (not shown) of the vehicle component 102. The grounding component 214 may extend through the slot 208 such that it is received or housed in the cavity 211 of the retention portion 204b. The grounding component 214 includes a connecting portion 218a and a protrusion 218b. The connecting portion 218a is configured to be received in the cavity 211 and includes a generally circular periphery. In this way, the connecting portion 218a cooperates with the retention portion 204b to inhibit rotation of the grounding component 214 relative to the collar 204 about an axis 217 of an aperture 216. The connecting portion 218a also defines the aperture 216 extending therethrough and configured to receive a fastener 222 as will be described in more detail below. The protrusion 218b extends from the connecting portion 218a and is located external to the cavity 211 of the retention portion 204b. A wire 227 may extend from the protrusion 218b and may be coupled to the body 103 of the vehicle component 102. In some forms, the wire 227 may be surrounded by a sheath.

With continued reference to FIGS. 2A-2D, the aperture 210 is configured to receive the fastener 222 and opens through a second side 209 of the tab 204b that is perpendicular to the first side 207 of the tab 204b. The aperture 210 is in communication with the cavity 211 and has a diameter that is greater than a diameter of the aperture 216 of the grounding component 214. Optionally, in one variation, a rib 205 extends from the second side 209 of the tab 204b to the vehicle component portion 204a to provide additional support to the tab 204b.

The tab 204b may include an optional compression limiter 212 (FIG. 2A) disposed at least partially within the cavity 211 thereof. The compression limiter 212 is configured to strengthen the tab 2204b and withstand compressive forces applied to the tab 204b during assembly of the vehicle component 102 to the vehicle 201. The compression limiter 212 includes a first axial end 213 and a second axial end 215. An axial surface 223 of the first axial end 213 is flush with a third side 219 of the tab 204b (FIG. 2D). The third side 219 of the tab 204b is opposite the second side 209 of the tab 204b and perpendicular to the first side 207 of the tab 204b. The second axial end 215 engages the grounding component 214 in response to the grounding component 214 being received in the cavity 211.

The fastener 222 extends through the aperture 210 of the tab 204b, the aperture 216 of the grounding component 214, and at least partially through the vehicle 201 to secure the vehicle component 102 to the vehicle 201 and provide an electrical pathway between the grounding component 214 and the vehicle 201. That is, the electrical pathway is formed between the grounding component 214, the fastener 222, and the vehicle 201 and electrically grounds the electrical components in the vehicle component 102. The fastener 222 may include any form of a fastening component such as, but not limited to, a bolt or a screw. The fastener 222, the grounding component 214 and the vehicle component 102 cooperate with each other to form a retention assembly 200 for retaining the vehicle component 102 to the vehicle 201 while also electrically grounding the wires of the vehicle component 102.

The part support 114 may support the vehicle components prior to processing. One example of a part support is disclosed in U.S. patent application Ser. No. ______/000,000, and titled “SYSTEM FOR HANDLING A COMPONENT OF A VEHICLE” which is commonly owned with the present application and the contents of which are incorporated herein by reference in its entirety. The robots 122 may move the vehicle component 102 from the part support 114 to the work surface 116 and from the work surface 116 to the vehicle 201. One example of one or more robots for moving the vehicle component 102 is disclosed in U.S. Patent App. No. XX/000,000, and titled “SYSTEM FOR HANDLING A COMPONENT OF A VEHICLE” and U.S. patent application Ser. No. ______/000,000, and titled “METHOD AND SYSTEM FOR INSTALLING WIRING HARNESS INTO VEHICLE” which are commonly owned with the present application and the contents of which are incorporated herein by reference in its entirety.

With reference to FIG. 5, a method 500 for assembling the vehicle component 102 to the vehicle 201 will be described in detail. At 504, a control algorithm using the controller, moves the vehicle component 102 via one or more robots from the work surface 116 to the vehicle 201. That is, the vehicle component 102 may be built up at the work surface 116 that is remote from a final vehicle assembly line and subsequently moved to the final vehicle assembly line to be coupled to the vehicle 201. At 508, control algorithm using the controller, inserts the grounding component 214 via one or more robots through the slot 208 into the cavity 211 of the tab 204b of the collar 204. In this way, the grounding component 214 is inhibited from rotating within the cavity 211 relative to the collar 204. At 512, the control algorithm using the controller, inserts the mechanical fastener 222 via one or more robots through the aperture 210 of the tab 204b, through the aperture 216 of the grounding component 214, and at least partially through the vehicle 201. In this way, the vehicle component 102 is secured to the vehicle 201 and an electrical pathway is formed between the grounding component 214 and the vehicle 201.

It should be understood that when the fastener 222 extends through the aperture 210 of the tab 204b, through the aperture 216 of the grounding component 214, and at least partially through the vehicle 201, a head 222a of the fastener 222 is received in the aperture 210 and a shaft 222b of the fastener 222 extends through the grounding component 214, the third side 219 of the collar 204 and at least partially through the vehicle 201. The head 222a of the fastener 222 also abuts against the grounding component 214, which facilitates electrical contact between the fastener 222 and the grounding component 214. In some forms, the fastener 222 extends through a rocker or sill of the vehicle 201. In other forms, the fastener 222 may extend through other structures of the vehicle 201 to support and electrically ground the vehicle component 102. In some forms, the grounding component 214 may be inserted into the cavity 211 of the collar 204 prior to the vehicle component 102 being moved to the vehicle 201. It should also be understood that the vehicle component 102 may be secured to the vehicle 201 as described above, manually, as opposed to using robots.

In another form not shown, the retention assembly (not shown) may further include the grounding component (not shown) that is directly coupled to the body (not shown) of the vehicle component (not shown). The grounding component includes the aperture that is configured to receive the fastener (not shown). The fastener is configured to extend at least partially through the vehicle to secure the body of the vehicle component to the vehicle and provide an electrical pathway between the grounding component and the vehicle.

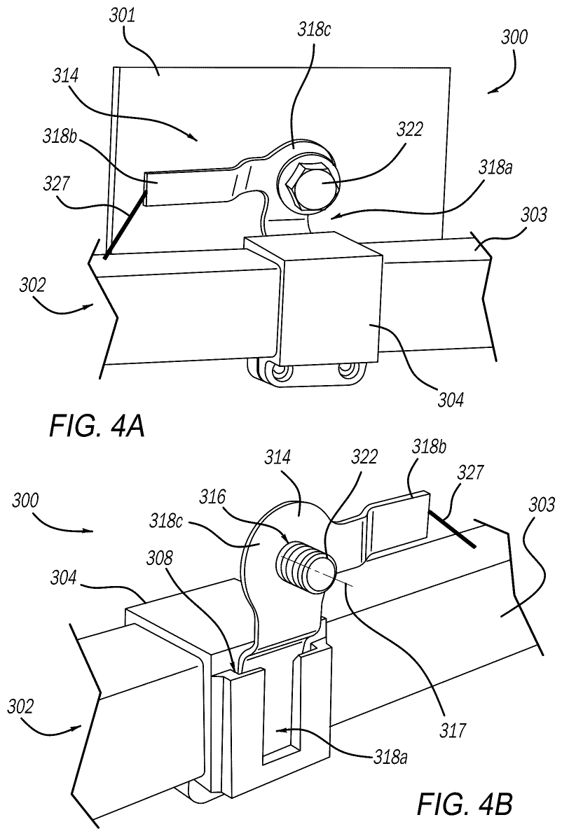

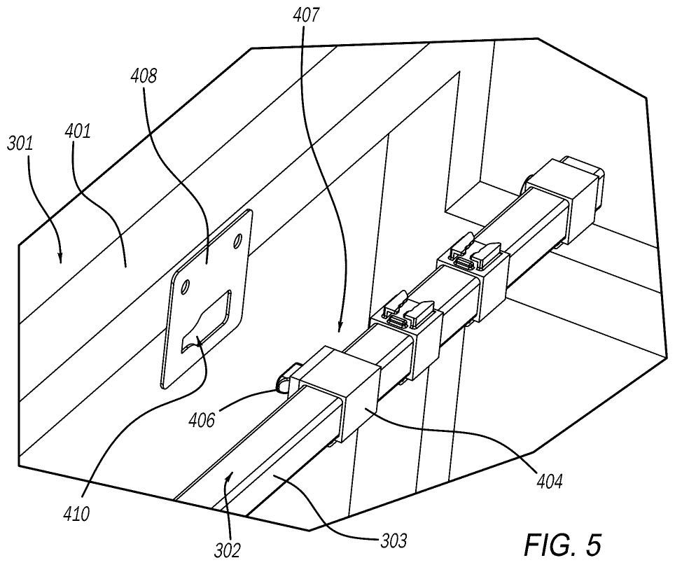

Referring to FIGS. 4A, 4B, and 5, another vehicle component 302 is illustrated. The structure and function of the vehicle component 302 may be similar or identical to the vehicle component 102 described above, apart from any exception noted below. With reference to FIG. 1, each vehicle component 302 includes a housing or body 303, first collars (not shown), second collars (not shown), at least one third collar 304, and at least one fourth collar 404. The body 303 may be made of a rigid material (e.g., metal or plastic) and may house electrical components (e.g., flexible wires). The structure and function of the body 303 may be similar or identical to the body 103 described above and therefore will not be described again in detail. The first collars may be coupled at opposing ends of the section of the vehicle component 302 and may be configured to attach the vehicle component 302 to a part support (not shown). The structure and function of the first collars may be similar or identical to the collars 104a described above and therefore will not be described again in detail. The second collars may be coupled to the vehicle component 302 between the first collars and may be configured to allow robot (not shown) to grasp the vehicle component 302 for moving from the part support to the fixture (not shown). The structure and function of the second collars may be similar or identical to the collars 104b described above and therefore will not be described again in detail.

The collar 304 is coupled to the body 303 and is configured to couple the vehicle component 302 to the vehicle 301 while providing an electrical ground from the vehicle component 302 to the vehicle 301 as will be described in more detail below. In the example illustrated, the collar 304 is made of a single, monolithic component that is disposed on the body 303 of the vehicle component 302. In some forms, the collar 304 may be made of two shells that are clamped around the body 303. In other forms, the collar 304 may be coupled to the body 303 by an interference fit or may be sleeved on the body 303. In yet another form, the body 303 may be manufactured (e.g., injection molded or 3D printed) to include the collar 304. In this way, the body 303 may be a unitary, monolithic component including the features of the collar 304 as described below.

The collar 304 defines a slot 308 (shown best in FIG. 4B) that is configured to receive a grounding component 314 that is configured to provide electrical grounding for the electrical components (not shown) of the vehicle component 302. The grounding component 314 includes a first protrusion 318a, a second protrusion 318b, and a connection portion 318c disposed between and connecting the first protrusion 318a and the second protrusion 318b. In the example illustrated, the first protrusion 318a extends at an angle relative to the second protrusion 318b. In one aspect, the first protrusion 318a extends at a ninety-degree angle relative to the second protrusion 318b. In other forms, the first protrusion 318a may extend at an obtuse angle or acute angle from the second protrusion 318b. The first protrusion 318a of the grounding component 314 may have a rectangular shape (i.e., has a periphery that includes flat sides forming a rectangular shape) and is configured to be received within the slot 308 of the body 303. In this way, the grounding component 314 cooperates with the body 303 to inhibit rotation of the grounding component 314 about an axis 317 of the first aperture 316 relative to the body 303.

A wire 327 may extend from the second protrusion 318b and may be coupled to the body 303 of the vehicle component 302. In some forms, the wire 327 may be surrounded by a sheath. The connecting portion 318c may define an aperture 316 that is configured to receive a fastener 322 as will be described in more detail below. In the example illustrated, the connecting portion 318c has a generally circular periphery. In some forms, however, the connecting portion 318c may have a rectangular periphery or a square periphery, for example. The fastener 322 extends through the aperture 316 of the grounding component 314 and extends at least partially through the vehicle 301 to secure the body 303 of the vehicle component 302 to the vehicle 301 and provide an electrical pathway between the grounding component 314 and the vehicle 301. The fastener 322 may include any form of a fastening component such as, but not limited to, a bolt or a screw. The vehicle component 302, the fastener 322, and the grounding component 314 cooperate to form the retention assembly 300.

Referring to FIG. 5, the collar 404 may be disposed about the body 303 of the vehicle component 302. In another form, the collar 404 may be integrally formed with the body 303 of the vehicle component 402. The collar 404 includes at least one protrusion 406 extending from a periphery 407 of the collar 404. In one form, the protrusion 406 forms an L-shaped body that is wider at a proximal end and narrows as a distal end of the protrusion 406. In another form, the protrusion 406 may form alternative geometries that are able to secure the vehicle component 302 to the vehicle body 301. The protrusion 406 of the collar 404 is configured to cooperate with a corresponding aperture 410 in a connection plate 408 of the vehicle body 301. In one form the connection plate 408 is detachably coupled to the vehicle body 301 (e.g., rocker or sill) via at least one fastener (not shown). In another form, the connection plate 408 may be integrally formed with the vehicle body 301. In one variation, as shown, the corresponding aperture 410 includes an insertion area or region that narrows toward a securement area or region. In this way, the protrusion 406 may be inserted into the insertion area of the aperture 410 and moved to the securement area, thereby further securing the vehicle component 302 to the vehicle 301. In other variations, the corresponding aperture 410 may take on other forms that correspond to the protrusion 406 of the collar 404. It should be understood that the collar 404 may be included on the body 103 of the vehicle component 102 described above without departing from the scope of the present disclosure.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C. ”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A retention assembly for coupling electrical components to a vehicle, the retention assembly comprising:
a body configured to house the electrical components, the body defining a slot;
a grounding component received in the slot of the body and defining a first aperture; and
a fastener extending through the first aperture of the grounding component and configured to extend at least partially through a vehicle body to secure the body to the vehicle and provide an electrical pathway between the grounding component and the vehicle body.

2. The retention assembly of claim 1, wherein the grounding component cooperates with the body to inhibit rotation the grounding component about an axis of the first aperture.

3. The retention assembly of claim 1, wherein the body is a wiring harness body.

4. The retention assembly of claim 1, wherein the body defines a second aperture, and wherein the fastener extends through the second aperture of the body.

5. The retention assembly of claim 1,
wherein the body includes a tab defining a cavity, the slot, and a second aperture; the slot and the second aperture are in communication with the cavity, the slot opens through a first side of the tab, and the second aperture opens through a second side of the tab,
wherein the grounding component is received in the cavity of the tab through the slot, and
wherein the fastener extends through the second aperture of the body.

6. The retention assembly of claim 5, further comprising a compression limiter disposed at least partially within the cavity of the tab.

7. The retention assembly of claim 6, wherein the compression limiter includes a first axial end and a second axial end, an axial surface of the first axial end is flush with a third side of the tab and the second axial end engages the grounding component, and wherein the third side is opposite the second side.

8. The retention assembly of claim 1, wherein the body includes a collar that defines the slot.

9. The retention assembly of claim 1, wherein the grounding component includes a protrusion extending from a periphery of the grounding component, and wherein the slot is configured to receive the protrusion of the grounding component to inhibit rotation of the grounding component relative to the body.

10. The retention assembly of claim 1, further comprising at least one collar disposed about the body, the at least one collar including a protrusion extending from a periphery of the at least one collar, wherein the protrusion of the at least one collar is configured to cooperate with a corresponding aperture in the vehicle body to further secure the body to the vehicle body.

11. A retention assembly for coupling electrical components to a vehicle, the retention assembly comprising:
a wiring harness body configured to house the electrical components, the wiring harness body defining a slot;
a grounding component received in the slot of the wiring harness body and defining a first aperture, the grounding component cooperating with the wiring harness body to inhibit rotation of the grounding component about an axis of the first aperture; and
a fastener extending through the first aperture of the grounding component, a second aperture of the wiring harness body, and configured to extend at least partially through a vehicle body to secure the wiring harness body to the vehicle body and provide an electrical pathway between the grounding component and the vehicle body.

12. The retention assembly of claim 11,
wherein the wiring harness body includes a tab defining a cavity, the slot, and a second aperture; the slot and the second aperture are in communication with the cavity, the slot opens through a first side of the tab, and the second aperture opens through a second side of the tab,
wherein the grounding component is received in the cavity of the tab through the slot, and
wherein the fastener extends through the second aperture of the wiring harness body.

13. The retention assembly of claim 12, further comprising a compression limiter disposed within the cavity of the tab.

14. The retention assembly of claim 13, wherein the compression limiter includes a first axial end and a second axial end, an axial surface of the first axial end is flush with a third side of the tab and the second axial end engages the grounding component, and wherein the third side is opposite the second side.

15. The retention assembly of claim 11, wherein the wiring harness body includes a collar that defines the slot.

16. The retention assembly of claim 11, further comprising at least one collar disposed about the wiring harness body, each collar of the at least one collar including a protrusion extending from a periphery of each collar, wherein each protrusion of each collar is configured to cooperate with a corresponding aperture in the vehicle body to further secure the wiring harness body to the vehicle body.

17. A retention assembly for coupling electrical components to a vehicle, the retention assembly comprising:
a wiring harness body configured to house the electrical components, the wiring harness body including a tab defining a cavity, a first aperture, and a second aperture, the first aperture and the second aperture are in communication with the cavity, the first aperture opens through a first side of the tab, and the second aperture opens through a second side of the tab;
a grounding component received in the cavity of the tab through the first aperture, the grounding component cooperating with the tab of the wiring harness body to inhibit a rotation of the grounding component about an axis of the first aperture, the grounding component defining a third aperture; and
a fastener extending through the second aperture of the tab, the third aperture of the grounding component, and configured to extend at least partially through a vehicle body to secure the wiring harness body to a vehicle body and provide an electrical pathway between the grounding component and the vehicle body.

18. The retention assembly of claim 17, further comprising a compression limiter disposed within the cavity of the tab, wherein the compression limiter includes a first axial end and a second axial end, an axial surface of the first axial end is flush with a third side of the tab and the second axial end engages the grounding component, and wherein the third side is opposite the second side.

19. The retention assembly of claim 17, wherein the wiring harness body includes a collar that defines the tab.

20. The retention assembly of claim 11, further comprising at least one collar disposed about the wiring harness body, the at least one collar including a protrusion extending from a periphery of the at least one collar, wherein the protrusion of the at least one collar is configured to cooperate with a corresponding aperture in the vehicle body to further secure the wiring harness body to the vehicle body.
